(19) United States
(12) Patent Application Publication
(10) Pub. No.: US 2025/0091469 A1
(43) Pub. Date: Mar. 20, 2025

(54) ELECTRIC VEHICLE CHARGING DETECTION SYSTEMS AND METHODS

(71) Applicant: PEAK POWER, INC., Toronto (CA)

(72) Inventors: Meysam Sahafzadeh, Toronto (CA); Shuang Ao, Maple (CA)

(21) Appl. No.: 18/470,997

(22) Filed: Sep. 20, 2023

(51) Int. Cl. B60L 53/65; B60L 53/62

(52) U.S. Cl. CPC B60L 53/65; B60L 53/62; B60L 2260/46; B60L 2260/54

(57) ABSTRACT

A system can include a data processing system. The data processing system can include one or more memory devices coupled with one or more processors. The data processing system can receive data indicating power consumption at a building at a plurality of points in time, the power consumption at the building including power consumption of an electric vehicle charging at the building. The data processing system can generate a plurality of features from the power consumption at the building at the plurality of points in time. The data processing system can execute a model trained by machine learning based on the plurality of features to detect that the electric vehicle charges at the building.

### BACKGROUND

Energy systems such as a power plant can generate and provide power throughout a utility grid to a variety of distributed end points.

### SUMMARY

At least one aspect of the present disclosure is directed to a system. The system can include a data processing system including one or more memory devices coupled with one or more processors. The data processing system can receive data indicating power consumption at a building at points in time, the power consumption at the building including power consumption of an electric vehicle charging at the building. The data processing system can generate features from the power consumption at the building at the points in time. The data processing system can execute a model trained by machine learning based on the features to detect that the electric vehicle charges at the building.

At least one aspect of the present disclosure is directed to a method. The method can include receiving, by one or more processing circuits, data indicating power consumption at a building at points in time, the power consumption at the building including power consumption of an electric vehicle charging at the building. The method can include generating, by the one or more processing circuits, features from the power consumption at the building at the points in time. The method can include executing, by the one or more processing circuits, a model trained by machine learning based on the features to detect that the electric vehicle charges at the building.

At least one aspect of the present disclosure is directed to one or more storage media. The one or more storage media can store instructions thereon. The instructions, when executed by one or more processors, can cause the one or more processors to receive data indicating power consumption at a building at points in time, the power consumption at the building including power consumption of an electric vehicle charging at the building. The instructions can cause the one or more processors to generate features from the power consumption at the building at the points in time. The instructions can cause the one or more processors to execute a model trained by machine learning based on the features to detect that the electric vehicle charges at the building.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an example system that detects whether an electric vehicle charges at a building.

FIG. 2 is an example method of extracting features from consumption data of a building and executing a model to detect whether an electric vehicle charges at a building.

FIG. 3 is an example method of detecting whether an electric vehicle charges at a building.

FIG. 4 is an example computing architecture of a data processing system.

### DETAILED DESCRIPTION

Following below are more detailed descriptions of various concepts related to, and implementations of, methods, apparatuses, and systems of electric vehicle charging detection. The various concepts introduced above and discussed in greater detail below may be implemented in any of numerous ways.

An energy system, such as an electricity grid or utility, can generate, provide, or deliver energy or power to buildings where electric vehicles charge, such as commercial or residential buildings. However, the energy system may not include detailed information regarding which buildings electric vehicles charge at, and which buildings electric vehicles do not charge at. Furthermore, the energy system may not have data that indicates or predicts the rate at which consumers acquire electric vehicles and begin charging the electric vehicles at their home or business. This can create technical difficulties for the energy system to forecast electric demand or load and analyze the existing infrastructure to prevent damage to the hardware in a geographic region, which may be at risk due to increased electric load from electric vehicle charging. Furthermore, uncertainty in the growth of demand or load due to increases in electric vehicle charging can create technical difficulty for the energy system to detect outages, detected downed live wires, train or construct load or demand forecasting models, assist with grid planning, perform load balancing, rate design, or reduce carbon dioxide or other greenhouse gas emissions or pollutants.

The energy system can include a meter system, such as an advanced metering infrastructure (AMI), where meters are deployed at the buildings to measure the energy consumption or electric load the buildings. One solution to disaggregate the load data of the building to detect that an electric vehicle charges at the building can include implementing a complex deep learning algorithm. However, the complex deep learning algorithm can have various drawbacks. For example, the complex deep learning algorithm may use highly granular or detailed data. For example, for the complex deep learning algorithm to operate properly, the energy consumption data of a building may need to be collected every second, or more frequently than every second, depending on the configuration of the model.

Furthermore, the complex deep learning algorithm may need a variety of different data types to execute on. The complex deep learning algorithm can use weather data or weather trends for a geographic region. Furthermore, the complex deep learning algorithm can execute on energy consumption, charging or discharging patterns, or charging profiles of electric vehicles (e.g., data that indicates the load of an electric vehicle over time when it charges, such as kilowatts (kWs) versus time). The complex deep learning algorithm may not be able to execute unless charging profiles for the electric vehicles are available to train or execute on.

Often, the granular data used by the complex deep learning algorithm is not available to a system. For example, the charging profile of various different types of vehicles may not be available to a computing system. Furthermore, if the availability of a particular type of data changes, the computing system may need to re-train the complex deep learning algorithm to handle the changes in the underlying data that the complex deep learning model executes on. This need for retraining responsive to changes in data type availability can consume excessive amounts of processing, storage, or computing resources. The complex deep learning algorithm may not be a generally deployable solution for various systems, e.g., each system may need a complex deep learning algorithm trained specifically on the data types available to the system and the measurement rate of the interval data.

In this regard, the training dataset used to train the complex deep learning algorithm may be large, and require a substantial amount of memory or database resources. Similarly, the inference dataset used to detect the presence of an electric vehicle with the complex deep learning algorithm can be large and require a substantial amount of memory or database resources. Furthermore, to process these large datasets to train the complex deep learning model or generate inferences with the complex deep learning model can require substantial amounts of processing resources (e.g., processor or memory consumption).

Even though the complex deep learning model can generate an accurate classification, the complex deep learning model storage and processing resource needs can prevent the complex deep learning model from being utilized in a data processing system that does not include the processor, memory, or storage resources necessary to store, train, or execute the complex deep learning model. Furthermore, environments lacking the granular and specific data types that the complex deep learning model may use to execute can prevent the complex deep learning model from being deployed and run at all.

To solve for these, and other technical issues, this technical solution can include a data processing system that generates features from raw consumption data for a model to execute on. The system can determine whether an electric vehicle typically charges at the building, e.g., where an electric vehicle charger is installed to charge a vehicle from raw consumption data collected by a meter deployed at the building. The meter can provide interval data or periodic load or energy consumption data, e.g., kW of a building at a sampling rate. The data processing system can execute the model based on a variety of different sample rates, e.g., 15 minute interval data, 30 minute interval data, or hourly interval data.

The technical solution can include generating or extracting features from the interval data received by the data processing system. Instead of applying the interval data directly to a model, the data processing system can process the interval data to generate or extract features with timeseries processing, e.g., Fourier transforms. The features can be or include peaks. The peaks can be events or times when the consumption of a building exceeds or meets a threshold or the rate at which the consumption of the building increases exceeds or meets a threshold. The features can include patterns. The patterns can be the rate at which the peaks occur. A model can be trained to execute on the features generated by the timeseries processing. Because the data processing system extracts the peaks and pattern features, the model trained by machine learning can execute on underlying interval data with low granularity, e.g., consumption data collected on a variety of different sample rates, e.g., 15 minute interval data, 30 minute interval data, or hourly interval data. The model of the technical solution can execute on data with a lower sampling rate compared to a sample rate required for the complex deep learning model to execute on.

Because the model can use less granular data, the model can be lower in complexity compared to the complex deep learning model (e.g., fewer layers, weights, or processing steps). This can result in less memory resources being needed to train or execute the model of the present solution compared to the complex deep learning model or another technique, such as a rule based analysis technique. However, even though the model of the present solution can have a lower complexity, require lower data granularity, or require less types of data, the model can still provide the same or a higher classification accuracy compared to the complex deep learning model or another accurate technique.

The model of the present technical solution can be applicable for a variety of different systems with different processing resource levels, storage resources, memory resources, data types available, and interval data granularities. This can allow the model of the present solution to be deployed across various different types of hardware or processing systems without requiring re-training or re-design. Furthermore, as long as the system has access to interval data, changes to the underlying data types of a system do not affect the ability to execute the model of the present technical solution, and the changes do not require re-training of the model. Furthermore, because the model of the present technical solution may only use the underlying interval data and not require charging profiles to be trained or execute, the system can execute even when charging profiles of electric vehicles are unavailable.

With the detections and classifications of the present solution, the data processing system or another system of a utility can identify regions at risk (such as risk of overloading transformers) due to high electric vehicle presence. Energy consumption can be better forecasted with the detections by the model of the present solution, and therefore energy production can be better controlled by the energy system. Furthermore, the energy system can plan infrastructure updates, or enhancement accurately with the electric vehicle presence detection. Local distribution systems can utilize the model of the present solution in regional-level forecasting to increase accuracy dynamically with software tools capable of analyzing historical and real-time data to develop data-driven analytical tools.

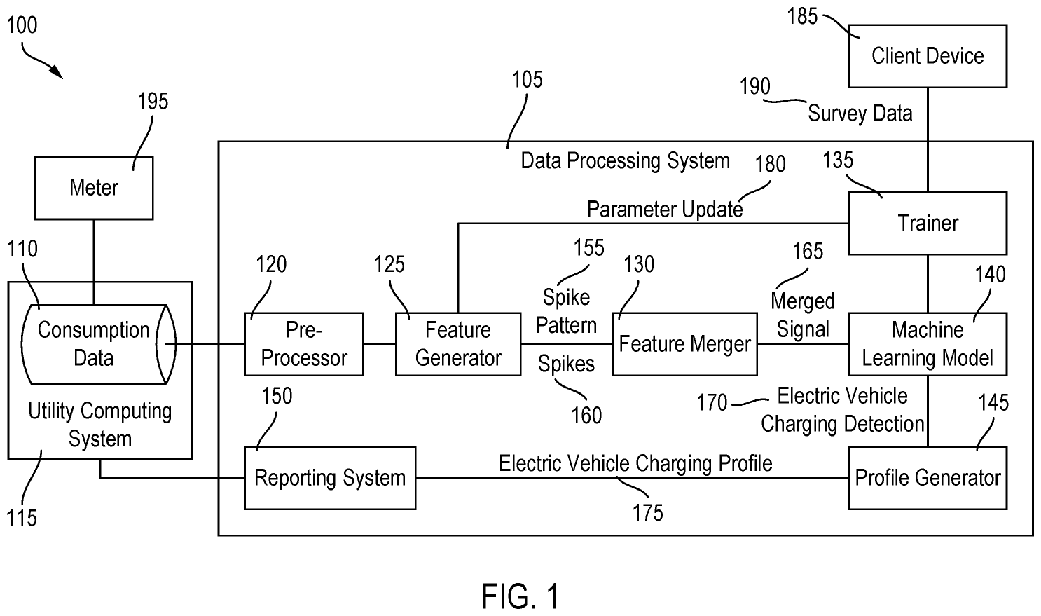

Referring now to FIG. 1, among others, an example system 100 that detects whether an electric vehicle charges at a building is shown. The system 100 can include at least one data processing system 105. The data processing system 105 can be a computing system, computing hardware, a server system, a cloud platform, a group of computing devices or systems, an on-premises system, an off-premises system, or a hybrid on-premises and off-premises system. The system 105 can be or include processing circuits, processing circuitry, memory devices, storage resources, databases or other processing or storage components. The data processing system 105 be a cloud system in order to prevent the spread of private consumption data 110 to a variety of different systems. The cloud system can be a cloud system that provides data privacy. The cloud system can perform an initial data transfer, data pre-processing, model tuning/testing, and algorithm optimization.

The system 100 can include at least one utility computing system 115. The utility computing system 110 can be a computing system of an electric grid, a power grid, an energy grid, or an electric utility. The utility computing system 110 can include similar hardware as the data processing system 105. The system 100 can include at least one database to store the consumption data 110. The consumption data 110 can be interval data, timeseries data, a stream of data, or data points collected, measured, or generated by a meter 195. The meter 195 can be a power meter disposed, included, or coupled with a building. The system 100 can include at least one meter 195. The system 100 can include multiple meters 195, each meter 195 to measure power at a different building or a different set of buildings.

The utility computing system 115 can collect, store, or aggregate the measurements of the meters 195 into the consumption data 110. The consumption data 110 can include multiple sets of consumption data, one set of consumption data for each meter 195 or for each building. The consumption data 110 can be measured at an interval, e.g., every second, every minute, every ten minutes, every fifteen minutes, every half hour, every hour, every hour and a half, every two hours, among other intervals. The consumption data 110 can be collected at a rate equal to or greater than one second. The rate can be equal to or greater than one minute. The rate can be equal to or greater than ten minutes. The rate can be equal to or greater than fifteen minutes. The rate can be equal to or greater than an hour. The consumption data 110 can be or included timeseries data.

The data processing system 105 can include at least one pre-processor 120. The pre-processor 120 can pre-process the consumption data 110 before the consumption data 110 is used to train a machine learning model 140 or before the consumption data 110 is used by the machine learning model 140 to generate an electric vehicle charging detection 170. The pre-processor 120 can pre-process the consumption data 110 of a specific service territory that the machine learning model 140 is trained or executes for. The pre-processor can normalize the consumption data 110 to remove a base-load from the consumption data 110. The pre-processor 120 can extrapolate or interpolate the consumption data 110 to fill in missing data points or data values. The pre-processor 120 can up-sample or down-sample consumption data 110 such that all of the consumption data 110 has the same sampling rate. For example, a first meter 195 at a first building may have a sampling rate different than a second meter 195 of a second building. The pre-processor 120 can up-sample or down-sample the consumption data 110 of the two buildings such that the consumption data 110 of the two buildings have the same sampling rate.

The consumption data 110 can include at least one, or only one, year of measurements for buildings of the service territory. For example, the consumption data 110 can indicate consumption levels at a building at multiple points in time for at least a year. By using at least one year of measurements, the machine learning model 140 can analyze or be tuned to analyze the seasonality impact of the consumption data 110. By taking into account seasonality in the data, the machine learning model 140 can distinguish between electric vehicle charging spikes and energy consumption spikes caused by heating or cooling systems.

The consumption data 110 can indicate an amount, level, or value of power consumption at a building at multiple points in time. The value can be in watts or kW. The points in time can be a month, day, year, hour, minute, or second at which a measurement was taken by the meter 195. The consumption data 110 can be a total power consumption at an address or a service location. The consumption data 110 can include power consumption of electric vehicles at the building, lights of the building, heating, cooling, and ventilation systems of the building, appliances of the building, electronic equipment of the building, or any other power consuming device, system, or apparatus of the building, disposed at the building, disposed within the building, or disposed near the building. The power consumption data 110 can be a total power consumption of the building, e.g., of all power consuming devices and equipment of the building.

The data processing system 105 can include at least one feature generator 125. The feature generator 125 can generate the features 155 or 160 for a particular building from the power consumption data 110 of the building at the points in time. The feature generator 125 can generate or extract features 155 or 160 from the pre-processed consumption data 110. The feature generator 125 can implement, execute, or run timeseries processing or a timeseries algorithm to generate the features 155 or 160 from the timeseries data of the consumption data 110. The timeseries processing can include at least one Fourier transform. The timeseries processing can be configured via at least one parameter or set of parameters. The parameters can cause the timeseries processing to generate features in a particular manner or generate features if certain conditions are met in the consumption data 110. During training, the timeseries processing can be initialized or started with initial parameter values.

The feature generator 125 can generate at least one spike 160. The spike 160 can be an indication that power consumption at a building has increased above a threshold level or has increased at a rate above a threshold rate. The spike 160 can be an indication that power consumption at a building has increased above a threshold level and has increased at a rate above a threshold rate. The spike 160 can be an indication that a frequency of the power consumption 110 of a building is greater than a threshold frequency at a particular time, e.g., the frequency in a change in the power consumption 110 increasing is greater than a threshold.

The spike pattern 155 can indicate a pattern of the spikes 160 in the power consumption 110 at the building. The spike pattern 155 can be an indication of how frequently spikes 160 occur, e.g., a frequency at which the spikes 160 occur. The spike pattern 155 can be an indication of a duration of time over which the spikes 160 occur, or a duration of time over which the spikes 160 occur in a particular pattern. The spike pattern 155 can be an indication of the months, days, weeks, or years during which the spikes 160 occur at a particular frequency. For example, the spike pattern 155 can be an indication that the spikes 160 occur every day from June to August. The spike pattern 155 can be an indication that the spikes 160 occur every day year round. The spike pattern 155 can indicate the average number of spikes that occur during a time window, e.g., an average number of spikes per day, an average number of spikes per week, an average number of spikes per month, and average number of spikes per year.

The feature generator 125 can generate the features 155 or 160 from the consumption data 110. The feature generator 125 can generate the features 155 or 160 solely, only, or exclusively on the consumption data 110. For example, the feature generator 125 may not need or execute on data other than the consumption data 110 or various parameters or settings for the feature generator 125. For example, the feature generator 125 may not use weather data, vehicle charging profiles, or other data.

The data processing system 105 can include at least one feature merger 130. The feature merger 130 can merge the features 160 and 155 into one single dataset or into one single signal 165. For example, the consumption data 110 for a particular building can begin as one single signal or one single dataset, but be split into two separate signals, e.g., the spike pattern features 155 and the spike features 160 by the feature generator 125. The feature merger 130 can merge the features 155 and 160 together into one merged signal 165 for processing by the machine learning model 140.

The data processing system 105 can execute a machine learning model 140. The model 140 can be trained via a machine learning algorithm or process by a trainer 135. The trainer 135 can train the model 140 based on the features 155 or 160. The trainer 135 can train the model 140 based on the one merged signal 165. The trainer 135 can tune, generate, or adjust weights of the model 140. The trainer 135 can generate a training dataset from the merged signal 165, the spike pattern 155, or the spikes 160. The trainer 135 can train the machine learning model 140 based on survey data 190.

The trainer 135 can generate the training data with the survey data 190. The training dataset can include a set of buildings surveyed. The training dataset can include only those buildings that the survey data 190 indicates an electric vehicle charges at, or where an electric vehicle does not charge at. The trainer 135 can form the training dataset to include multiple indications of buildings, indications that a first set of the buildings have electric vehicles that charge at the buildings, indications that a second set of the buildings do not have an electric vehicle that charges at the building, and features 155 or 160 for each building generated from the consumption data 110 of each building. The survey data 190 can be collected for a sample, or a sub-set of a buildings of a particular geographic region. The survey data 190 can provide or include label data labeling each building as being associated with an electric vehicle owner or being associated with a non-electric vehicle owner. The label data can be used for training or tuning the machine learning model 140 or the feature generator 125.

The trainer 135 can train the model 140 with the training dataset. For example, the trainer 135 can train the model 140 with the indications that electric vehicles charge at a first set of the buildings, indications that no electric vehicle charges at the second set of buildings, and the features 155 or 160 for each building. The trainer 135 can fit or tune the machine learning model 140 based on a training dataset. The trainer 135 can execute gradient boosting to generate a gradient boost model 140. The trainer 135 can sequentially build a sequence of models that reduce errors produced in prior models to create a set of models 140 that together can accurately generate electric vehicle charging detections 170. The trainer 135 can implement mean squared error, log-likelihood, or another minimization loss function to generate the model 140. In some implementations, the model 140 can be a neural network, a Bayesian classifier, a decision tree, or any other type of supervised machine learning model. The model 140 can execute in real-time, or near real-time such that a detection 170 can be generated rapidly or with low delay responsive to receiving a request to generate the detection 170.

The trainer 135 can train the model 140 exclusively on, or only on, the consumption data 110, the features 155 or 160, or the merged signal 165. For example, the consumption data 110 can be the only main input for training or executing the model 140. The trainer 135 may not be trained on any other input data. For example, the trainer 135 may not train the machine learning model 140 on any type of charging profile of an electric vehicle, e.g., a profile, plot, or trend that indicates power consumption in kW over various points in time of an electric vehicle when the electric vehicle charges. The trainer 135 can train on underlying consumption data 110 of a variety of different sampling frequencies or intervals, e.g., sampling rates of seconds, minutes, half hours, or hours.

The trainer 135 can update the feature generator 125 during training of the machine learning model 140. The trainer 135 can update the feature generator 125 after training the machine learning model 140. The trainer 135 can adjust, tune, or update parameters, settings, or values of the feature generator 125. The trainer 135 can run a minimization or optimization (e.g., mean squared error, log loss, steepest descents, conjugate gradients) to adjust the parameters of the feature generator 125 to improve the performance or accuracy of the machine learning model 140. For example, the timeseries processing can include one or multiple parameters that define the generation of spikes 160 or spike patterns 155. The trainer 135 can generate at least one parameter update 180. The parameter update 180 can be or include a change to a value of the parameters that the timeseries processing runs or executes on to generate the features 155 or 160. The parameter update 180 can be an update to an initial value of parameters of the timeseries processing. Based on the parameter update 180, the feature generator 125 can generate different features 155 or 160. These second features 155 or 160, can be different than first features 155 or 160 generated on the same consumption data 110.

The machine learning model 140 can be executed based on the consumption data 110 to generate an electric vehicle charging detection 170. The machine learning model 140 can execute on the features 155 or 160. The machine learning model 140 can execute on the merged signal 165. The machine learning model 140 can generate a classification for a particular building. For example the data processing system 105 can execute a gradient boost model 140 based on the features 155 or 160 to output a classification that indicates that the electric vehicle charges at the building.

The machine learning model 140 can execute on data of buildings one at a time, e.g., operate on a merged signal 165 of a first building to generate a first detection 170 for the first building. Then, the machine learning model 140 can execute on data of a merged signal 165 of a second building to generate a second detection 170 for the second building. The detection 170 can indicate that an electric vehicle charges at a particular building. The detection 170 can indicate that an electric vehicle does not charge at the particular building. The detection 170 can be a binary indicator or value. For example, the detection 170 can indicate that the electric vehicle charges regularly at the particular building, e.g., daily, weekly, monthly. The detection 170 can indicate that an electric vehicle charged at least a particular number of times at the building during a time period, e.g., at least one time per week, at least three times per month, etc.

The data processing system 105 can include at least one profile generator 145. The profile generator 145 can generate a charging profile 175. The charging profile 175 can indicate the power consumption of an electric vehicle at a particular building for a duration of time when the electric vehicle charges. The profile generator 145 can generate the charging profile 175 from the features 160 or 155 responsive to the model 140 detecting that an electric vehicle charges at the building. The profile generator 145 can generate a profile for a building responsive to detecting, via the detection 170, that an electric vehicle charges at the building.

The data processing system 105 can include at least one reporting system 150. The reporting system 150 can generate at least one message that identifies a building and whether an electric vehicle charges at the building or not. The message can include an indication of the building, e.g., an address of the building, a name of the building, an owner of the building. The message can include the electric vehicle charging detection 170 for the corresponding building. The reporting system 150 can transmit the message or a set of messages to the utility computing system 110.

The reporting system 150 can generate a report. The reporting system 150 can transmit the report to the utility computing system 115. The report can indicate the number and location of electric vehicle chargers. For example, the reporting system 150 can generate an indication that an electric vehicle charger is present at a building responsive to a detection 170. The reporting system 150 can aggregate electric vehicle chargers by geographic region, and indicate the numbers of electric vehicles within a service area, within a particular sub-set of the service area, or in a particular neighborhood, for example. The report can include a map. The map can indicate locations feeders or transformers of the electric utility or geographic areas that feeders or transformers service. The map can overlay the number and location of electric vehicle chargers. The map can indicate the number of electric vehicle chargers that the feeders or transformers provide power to. The report or the map can highlight feeders or transformers that are at risk of encountering a fault due to a number of electric vehicles being greater than a threshold.

The data processing system 105 or the utility computing system 115 can implement a forecasting tool that operates based on the electric vehicle charging detections 170. The tool can be a distribution level forecasting tool that uses the charging profile 175 or an energy profile pattern of vehicle charging to forecast load of the utility in various geographic regions. The utility computing system 115 can operate on the forecasts of the tool to control energy production to respond to predicted increases or decreases in electric loads caused by electric vehicle charging. The tool can be used to implement improvements in distribution system planning, feeding into the long-term planning process and data disaggregation for identifying electric vehicles embedded in a utility territory. The tool can provide data exploration to extract information on weather impacts, charging patterns, charging levels, and the corresponding effects on transformers or feeders.

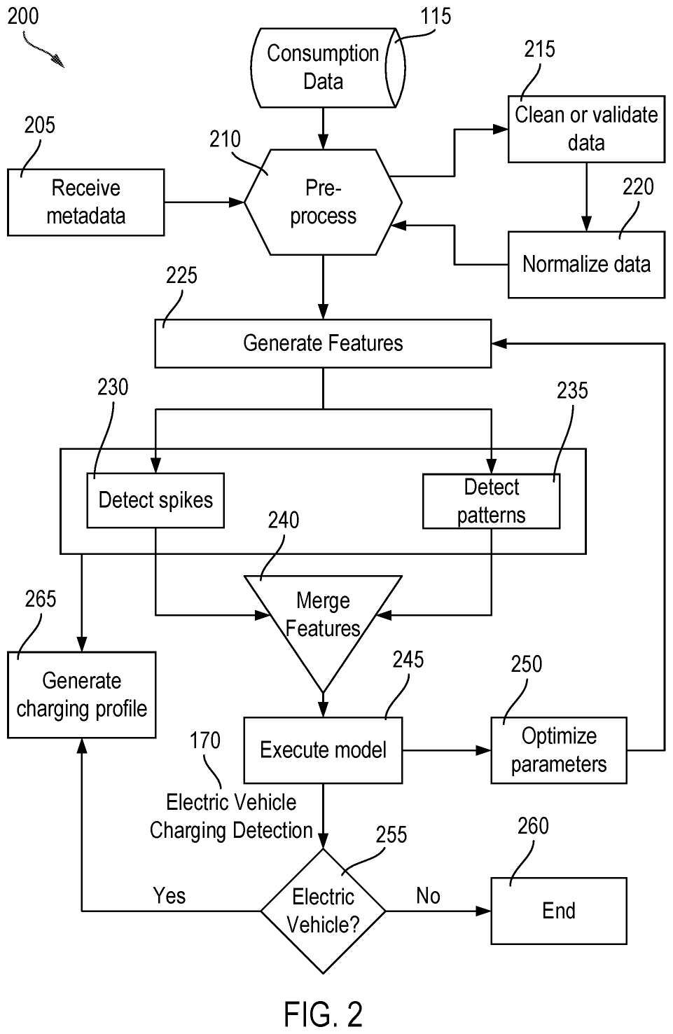

Referring now to FIG. 2, among others, an example method 200 of extracting features 155 or 160 from the consumption data 110 of a building and executing a model 140 to detect whether an electric vehicle charges at a building is shown. The data processing system 105 can perform at least a portion of the method 200. The utility computing system 115 can perform at least a portion of the method 200. At least a portion of the method 200 can be performed by the meter 195. At least a portion of the method 200 can be performed by the client device 185, (e.g., at least one server, personal, fixed, remote, mobile, tablet, handheld, or desktop computer).

The method 200 can include an ACT 205 of receiving metadata. The method 200 can include an ACT 210 of pre-processing. The method 200 can include an ACT 215 of cleaning and validating data. The method 200 can include an ACT 220 of normalizing data. The method 200 can include an ACT 225 of generating features. The method 200 can include detecting spikes. The method 200 can include an ACT 235 of detecting patterns. The method 200 can include an ACT 240 of merging features. The method 200 can include an ACT 245 of executing a model. The method 200 can include an ACT 250 of optimizing parameters. The method 200 can include an ACT 255 of detecting if an electric vehicle charges at a building. The method 200 can include an ACT 260 of ending the method 200. The method 200 can include an ACT 265 of generating a charging profile.

At ACT 205, the method 200 can include receiving, by the data processing system 105, metadata. The data processing system 105 can use the metadata to fill in gaps in the consumption data 110. The metadata can indicate charging levels of various chargers at buildings. While the client device 185 can provide survey data 190 that indicates which buildings include electric vehicle chargers or where electric vehicles charge, the metadata can indicate the charging levels of the chargers, e.g., level 1 chargers, level 2 chargers, level 3 chargers.

At ACT 210, the method 200 can include pre-processing, by the data processing system 105, the consumption data 110. The pre-processing can be an ACT performed by the data processing system 105 before features 155 or 160 are generated from the consumption data 110 or before the model 140 is executed. For example, all energy consumption data 110 in a service territory can be pre-processed to be prepared for further analysis.

At ACT 215, the method 200 can include cleaning or validating, by the data processing system 105, the consumption data 110. The data processing system 105 can clean data by interpolating data points, extrapolating data points, filling in gaps in the data, or filling in missing data values. The data processing system 105 can check the consumption data 110 for multiple buildings, and detect if the consumption data 110 has any anomalies or data inconsistencies. For example, the data processing system 105 can remove or average out data outliers (e.g., values above or below a threshold).

At ACT 220, the method 200 can include normalizing, by the data processing system 105, the consumption data 110. The normalization can include removing, by the data processing system 105, a base load from the consumption data 110. For example, the normalization can include eliminating a base load from each interval data 110. Furthermore, the normalization can include up sampling or down sampling the consumption data 110. For example, the consumption data 110 can be received from different utilities, different utility systems, or different meters 195 that collect or store consumption data 110 at different sampling rates. For example, consumption data 110 received from a first data source can be sampled every five minutes, while consumption data 110 received from a second data source can be sampled every hour. The data processing system can normalize the consumption data 110 to have the same sampling rate. For example, the data processing system 105 can normalize the consumption data 110 such that every consumption data stream 110 for each building can have the same sampling rate.

At ACT 225, the method 200 can include generating, by the data processing system 115, features. For example, the data processing system 115 can generate spike features 160 or spike patterns 155. The method 200 can include two separate feature generation or extraction pipelines. At ACT 230, the method 200 can include detecting, by the data processing system 105, spikes 160. The spikes 160 can be features that indicate a time when the consumption level of a building increased at a rate greater than a threshold and increased to a magnitude or amplitude above a threshold.

At ACT 235, the method 200 can include detecting patterns 155. The data processing system 105 can detect how frequently the spikes 160 occur or the rate at which they occur. The method 200 can include implementing time-series processing techniques, such as Fourier transformation, to detect spikes 160 and determine spike patterns 155. The features 155 and 160 can indicate a number of spikes occurring in the consumption data 110 within a time window or over a period of time (e.g., increases in power at a rate above a threshold to a magnitude or amplitude above a threshold). The features 155 and 160 can be used by the trainer 135 to develop, generate, train, or tune the model 140 with machine learning so that the model 140 can detect electric vehicle charging profiles in the total consumption data 110. The time-series processing can convert time-series data 110 in a time domain to data in a frequency domain. For example, the entire time-series data 110 can be transformed into the frequency domain.

At ACT 240, the method 200 can include merging, by the data processing system 105, features. The feature merger 130 of the data processing system 105 can combine the spike patterns 155 and the spikes 160 into a merged signal 165. The spike patterns 155 and the spikes 160 can be merged into one signal, or only one signal 165. The signal 165 can be a dataset for one particular building, or a dataset of spike patterns 155 and spikes 160 for specific buildings of a group of buildings. The feature merger 130 can generate multiple merged signals 165, e.g., each merged signal 165 specific to a particular building and including the spike patterns 155 and spikes 160 for the consumption data 110 of the particular building.

The time-series processing can be configured or set up to run based on at least one initial value, setting, or parameter. The features 155 and 160 generated based on the initial parameters can be used for training the model 140, such as a gradient boost supervised classifier. Once the model is trained, the parameters of the time-series processing can be updated or tuned to improve the performance of the model 140. The training of the model 140, and the updating of the parameters can be performed iteratively in multiple cycles.

At ACT 245, the method 200 can include executing, by the data processing system 105, a model. The data processing system 105 can generate the electric vehicle charging detections 170 based on the features 155 and 160. The data processing system 105 can execute the model 140 based on the merged signal 165. Responsive the merged signal 165, the features 155, or the features 160 being generated, the data processing system 105 can execute the model 140 to generate the electric vehicle charging detection 170.

At ACT 250, the method 200 can including optimizing, by the data processing system 105, parameters. For example, the trainer 135 can generate a parameter update 180. The parameter update 180 can be an adjustment, an increase, a decrease, or change to a value of a parameter of the feature generator 125. For example, the trainer 135 can run an optimization, a minimization, a maximization to determine the parameter updates 180 that improve the detections 170 of the model 140 or optimize the detections 170 of the model 140. The trainer 135 can continuously or iteratively update or change the parameters of the feature generator 125 during a model development or training cycle to reach a classification accuracy greater than or equal to a threshold or highest classification accuracy.

At ACT 255, the method 200 can include determining whether an electric vehicle charges at a particular building. For example, the data processing system 105 can detect whether an electric vehicle charges at a particular building at least once a week. The data processing system 105 can determine that the electric vehicle charges at the building at least a particular average number of times per week, month, quarter, or year. The data processing system 105 can determine that an electric vehicle charger or charging apparatus are installed or present at the building.

The data processing system 105 can determine portions of a total energy consumption signal that are correlated with an electric vehicle charger. The data processing system 105 can determine that the consumption data 110 associated with a particular spike or with particular spikes 160 of a building that charges an electric vehicle are associated with vehicle charging. The segment of the consumption data 110 can be identified from the spikes 160. For example, a segment or portion of the consumption data 110 that generates a spike 160 can be selected or copied for further processing at ACT 265 to determine a charging profile for an electric vehicle at the building.

At ACT 265, the method 200 can include generating, by the data processing system 105, a charging profile 175. The profile generator 145 can generate the electric vehicle charging profile 175 with the identified portions or segments of the consumption data 110. The generator 145 can indicate a charging level for a building. The profile or charging level can be approximated by the profile generator 145. The profile or charging level can be used for risk analysis. The profile generator 145 can generate a charging profile for the electric vehicle from the consumption data 110 that corresponds to spikes 160 of the consumption data 110. The profile generator 145 can merge, average, or combine the consumption data 110 to form a charging profile 175 for a vehicle that charges at the building. The profile generator 145 can remove a base load or of the building from the profile 175 or from the consumption data 110, such that the charging profile reflects only the power consumption of the vehicle, not the rest of the building. The profile

The reporting system 150 can generate a message, set of messages, or a report. The reporting system 150 can transmit the report to the utility computing system 115. The reporting system 150 can aggregate or combine charging profiles 175 of multiple buildings together into one file for the utility system 115. For example, the reporting system 150 can aggregate charging profiles for multiple geographic regions. The reporting system 150 can aggregate indicators, such as binary indicators, indicating the number of buildings in the geographic region that include vehicle charging or do not include vehicle charging. The reporting system 150 can aggregate vehicle charging indications for charging profiles 175 based on feeders or transformers that provide power to the corresponding buildings. In this regard, the reporting system 150 can indicate the number and charging profiles associated with buildings serviced by a particular feeder or transformer. The report can be a map identifying the location of various buildings, whether those buildings have a vehicle charger, or whether a vehicle charges at the various buildings.

The reporting system 150 can use the total amount of time that chargers spend charging, the total amount of power used for charging electric vehicles to generate a risk level for a geographic region, a feeder, or a transformer. The reporting system 150 can generate the risk level from the map. The reporting system 150 can overlay the risk levels onto the map. Based on the number, charging profile, or increases or decreases in numbers of chargers installed at buildings or frequency of charging of vehicles at buildings, the reporting system 150 can generate a risk level for a particular feeder or transformer. For example, the risk level can indicate the risk of a geographic region, specific feeder, or specific transformer being overloaded.

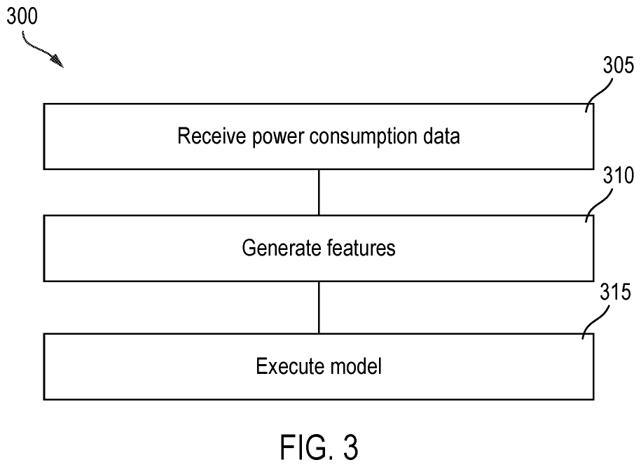

Referring now to FIG. 3, among others, an example method 300 of detecting whether an electric vehicle charges at a building is shown. The data processing system 105 can perform at least a portion of the method 300. The utility computing system 115 can perform at least a portion of the method 300. At least a portion of the method 300 can be performed by the meter 195. At least a portion of the method 300 can be performed by the client device 185. The method 300 can include an ACT 305 of receiving power consumption data. The method 300 can include an ACT 310 of generating features. The method 300 can include an ACT 315 of executing a model.

At ACT 305, the method 300 can include receiving, by the data processing system 105, power consumption data 110. The data processing system 105 can receive the power consumption data 110 from the utility computing system 115. The consumption data 110 can be data collected, measured, or generated by a meter 195 disposed in a building. The power consumption data 110 can indicate the amount of power consumed at a building at multiple points in time. The power consumption data 110 can indicate an amount of power consumed at a building at measurement intervals. The utility computing system 115 can collect power consumption data 110 from multiple different meters 195 disposed at multiple different buildings. Power consumption data 110 for a first building can include a label, such as an address or owner name of the building. The utility computing system 115 can transmit, send, or communicate the power consumption data 110 to the data processing system 105. The data processing system 105 can store power consumption data 110 in individual signals, e.g., one signal for each building. For example, the data processing system 105 can include a first timeseries of power measurements at a first building and a second timeseries of power measurements at a second building.

At ACT 310, the method 300 can include generating, by the data processing system, features 155 or 160. The feature generator 125 can generate spikes 160 from the consumption data 110. The feature generator 125 can execute timeseries processing on the consumption data 110 of each building. For example, the feature generator 125 can execute the timeseries processing on first timeseries data of a first building collected by a first meter 195. The feature generator 125 can execute the timeseries processing on second timeseries data of a second building collected by a first meter 195.

The feature generator 125 can generate spikes 160. The spikes 160 can be indications that power consumption at a building increased above a first threshold at a particular time and increased at a rate above a second threshold. The feature generator 125 can generate spikes 160 for each building. The feature generator 125 can generate spike patterns 155. The spike patterns 155 can be the number of spikes 160 that occur within a time window. The spike pattern 155 can indicate the seasonality of the spikes 160. The spike pattern 155 can indicate the frequency at which spikes occur. For example, the spike pattern 155 can indicate the average number of spikes that occur during a time period, e.g., weekly, daily, monthly, yearly. The spike pattern 155 can indicate the average time of day that the spikes occur, e.g., at night, in the afternoon, after 5 P.M.

At ACT 315, the method 300 can include executing, by the data processing system 105, a model. The data processing system 105 can execute the model 140 to generate the electric vehicle charging detection 170. The trainer 135 can train the model 140 based on at least a portion of the features generated at ACT 310. The trainer 135 can train or tune the parameters of the model 140 based on indications of which buildings include an electric vehicle charger or where an electric vehicle charges. The indications can be included in, or extracted from, the survey data 190. The training can include tuning or adjusting parameter values of the timeseries processing used to generate the features 155 or 160 at ACT 310.

With the trained model 140, the data processing system 105 can execute the model 140 on at least a portion of the features 155 or 160. The model 140 can output a classification of a building being a building where an electric vehicle charges or a building where an electric vehicle does not charge. The model 140 can execute on features 155 or 160 derived from consumption data 110 for one building at a time. For example, the model 140 can execute on first features 155 or 160 derived from first consumption data 110 of a first building to generate a first electric vehicle charging detection 170 for the first building. The model 140 can execute on second features 155 or 160 derived from second consumption data 110 of a second building to generate a second electric vehicle charging detection 170 for the first building. The model 140 can execute on features 155 or 160 of one building at a time. The model 140 may not execute on a mix features of multiple buildings.

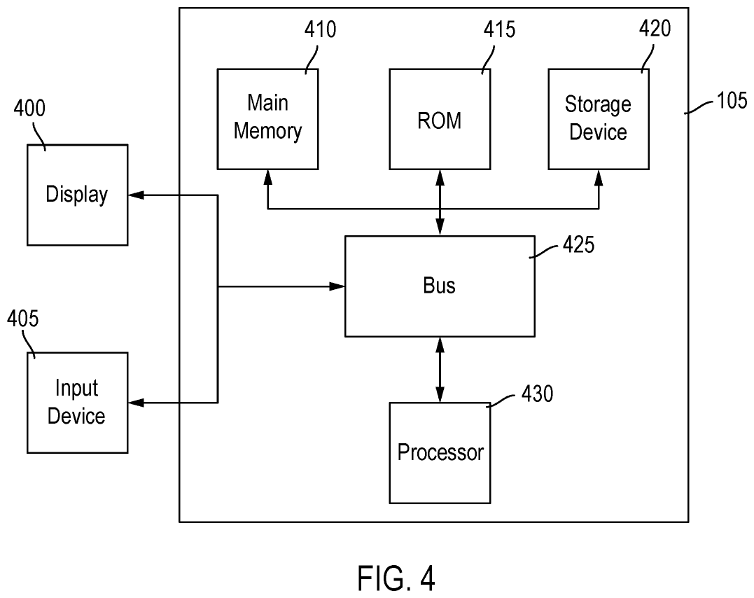

Referring now to FIG. 4, among others, an example block diagram of a data processing system 105 is shown. The data processing system 105 can include or be used to implement a data processing system or its components. The architecture described in FIG. 4 can be used to implement the data processing system 105, the utility computing system 115, or the client device 185. The data processing system 105 can include at least one bus 425 or other communication component for communicating information and at least one processor 430 or processing circuit coupled to the bus 425 for processing information. The data processing system 105 can include one or more processors 430 or processing circuits coupled to the bus 425 for processing information. The data processing system 105 can include at least one main memory 410, such as a random access memory (RAM) or other dynamic storage device, coupled to the bus 425 for storing information, and instructions to be executed by the processor 430. The main memory 410 can be used for storing information during execution of instructions by the processor 430. The data processing system 105 can further include at least one read only memory (ROM) 415 or other static storage device coupled to the bus 425 for storing static information and instructions for the processor 430. A storage device 420, such as a solid state device, magnetic disk or optical disk, can be coupled to the bus 425 to persistently store information and instructions.

The data processing system 105 can be coupled via the bus 425 to a display 400, such as a liquid crystal display, or active matrix display. The display 400 can display information to a user. An input device 405, such as a keyboard or voice interface can be coupled to the bus 425 for communicating information and commands to the processor 430. The input device 405 can include a touch screen of the display 400. The input device 405 can include a cursor control, such as a mouse, a trackball, or cursor direction keys, for communicating direction information and command selections to the processor 430 and for controlling cursor movement on the display 400.

The processes, systems and methods described herein can be implemented by the data processing system 105 in response to the processor 430 executing an arrangement of instructions contained in main memory 410. Such instructions can be read into main memory 410 from another computer-readable medium, such as the storage device 420. Execution of the arrangement of instructions contained in main memory 410 causes the data processing system 105 to perform the illustrative processes described herein. One or more processors in a multi-processing arrangement can be employed to execute the instructions contained in main memory 410. Hard-wired circuitry can be used in place of or in combination with software instructions together with the systems and methods described herein. Systems and methods described herein are not limited to any specific combination of hardware circuitry and software.

Although an example computing system has been described in FIG. 4, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, Python, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices including cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. ACTs, elements and features discussed in connection with one implementation are not intended to be excluded from a similar role in other implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any ACT or element being based on any information, act or element may include implementations where the act or element is based at least in part on any information, act, or element.

Any implementation disclosed herein may be combined with any other implementation or example, and references to “an implementation,” “some implementations,” “one implementation” or the like are not necessarily mutually exclusive and are intended to indicate that a particular feature, structure, or characteristic described in connection with the implementation may be included in at least one implementation or example. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A system, comprising:
a data processing system comprising one or more memory devices coupled with one or more processors, the data processing system to:
receive data indicating power consumption at a building at a plurality of points in time, the power consumption at the building including power consumption of an electric vehicle charging at the building;
generate a plurality of features from the power consumption at the building at the plurality of points in time; and
execute a model trained by machine learning based on the plurality of features to detect that the electric vehicle charges at the building.

2. The system of claim 1, comprising:
the data indicating power consumption levels at the building at the plurality of points in time for at least one year.

3. The system of claim 1, comprising the data processing system to:
receive timeseries data indicating power consumption levels at the building at the plurality of points in time; and
execute timeseries processing to generate the plurality of features from the timeseries data.

4. The system of claim 1, comprising the data processing system to:
execute timeseries processing based on a parameter to generate the plurality of features from the data;
generate, based on a classification of the model that detects that the electric vehicle charges at the building, an update to the parameter; and
execute the timeseries processing based on the update to the parameter to generate a plurality of second features from the data.

5. The system of claim 1, comprising:
the plurality of features including:
indications of spikes in the power consumption at the building greater than a threshold; and
indications of a patterns of the spikes in the power consumption at the building.

6. The system of claim 1, comprising the data processing system to:
generate a plurality of first features including indications of spikes in the power consumption at the building greater than a threshold;
generate a plurality of second features including indications of a pattern of the spikes in the power consumption at the building;
merge the plurality of first features and the plurality of second features into one signal; and
execute the model trained by machine learning based on the one signal to detect that the electric vehicle charges at the building.

7. The system of claim 1, wherein:
the model is not trained based on a charging profile of the electric vehicle.

8. The system of claim 1, comprising:
the data processing system to:
receive indications that electric vehicles charge at a first set of buildings and no electric vehicle charges at a second set of buildings; and
train the model with machine learning based on:
the indications that the electric vehicles charge at the first set of buildings and no electric vehicle charges at the second set of buildings; and
the plurality of features.

9. The system of claim 1, comprising the data processing system to:
generate a message comprising an address of the building and an indication that the electric vehicle charges at the building; and
transmit the message to a computing system of a utility to cause the utility to generate power for a power grid based on the message.

10. The system of claim 1, comprising the data processing system to:
generate a charging profile of the electric vehicle at the building based on at least one feature of the plurality of features responsive to the detection that the electric vehicle charges at the building.

11. The system of claim 1, comprising the data processing system to:
execute a gradient boost model based on the plurality of features to output a classification that indicates that the electric vehicle charges at the building.

12. The system of claim 1, comprising the data processing system to:
generate the plurality of features from only the power consumption at the building at the plurality of points in time measured by a meter disposed at the building; and
execute the model trained by machine learning based on only the plurality of features.

13. A method, comprising:
receiving, by one or more processing circuits, data indicating power consumption at a building at a plurality of points in time, the power consumption at the building including power consumption of an electric vehicle charging at the building;
generating, by the one or more processing circuits, a plurality of features from the power consumption at the building at the plurality of points in time; and
executing, by the one or more processing circuits, a model trained by machine learning based on the plurality of features to detect that the electric vehicle charges at the building.

14. The method of claim 13, comprising:
the data indicating power consumption levels at the building at the plurality of points in time for at least one year.

15. The method of claim 13, comprising:
executing, by the one or more processing circuits, timeseries processing based on a parameter to generate the plurality of features from the data;
generating, by the one or more processing circuits, based on a classification of the model that detects that the electric vehicle charges at the building, an update to the parameter; and
executing, by the one or more processing circuits, the timeseries processing based on the update to the parameter to generate a plurality of second features from the data.

16. The method of claim 13, comprising:
the plurality of features including:
indications of spikes in the power consumption at the building greater than a threshold; and
indications of a patterns of the spikes in the power consumption at the building.

17. The method of claim 13, comprising:
generating, by the one or more processing circuits, a plurality of first features including indications of spikes in the power consumption at the building greater than a threshold;
generating, by the one or more processing circuits, a plurality of second features including indications of a pattern of the spikes in the power consumption at the building;
merging, by the one or more processing circuits, the plurality of first features and the plurality of second features into one signal; and
executing, by the one or more processing circuits, the model trained by machine learning based on the one signal to detect that the electric vehicle charges at the building.

18. The method of claim 13, comprising:
generating, by the one or more processing circuits, the plurality of features from only the power consumption at the building at the plurality of points in time measured by a meter disposed at the building; and
executing, by the one or more processing circuits, the model trained by machine learning based on only the plurality of features.

19. One or more storage media storing instructions thereon, that, when executed by one or more processors, cause the one or more processors to:
receive data indicating power consumption at a building at a plurality of points in time, the power consumption at the building including power consumption of an electric vehicle charging at the building;
generate a plurality of features from the power consumption at the building at the plurality of points in time; and
execute a model trained by machine learning based on the plurality of features to detect that the electric vehicle charges at the building.

20. The one or more storage media of claim 19, wherein the instructions cause the one or more processors to:
generate a plurality of first features including indications of spikes in the power consumption at the building greater than a threshold;
generate a plurality of second features including indications of a pattern of the spikes in the power consumption at the building;
merge the plurality of first features and the plurality of second features into one signal; and
execute the model trained by machine learning based on the one signal to detect that the electric vehicle charges at the building.
